(19) United States
(12) Patent Application Publication
(10) Pub. No.: US 2008/0255910 A1
(43) Pub. Date: Oct. 16, 2008

(54) Method and System for Adaptive Project Risk Management

(76) Inventors: Sugato Bagchi, White Plains, NY (US); Stephen Buckley, White Plains, NY (US); Lea A. Deleris, Scarsdale, NY (US); Shubir Kapoor, Shrub Oak, NY (US); Kaan Katircioglu, Yorktown Heights, NY (US); Richard B. Lam, Danbury, CT (US)

Correspondence Address: Whitham, Curtis, & Christofferson, P.C., Suite 340, 11491 Sunset Hills Road, Reston, VA, 20190, US

(21) Appl. No.: 11/735,699

(22) Filed: Apr. 16, 2007

(51) Int. Cl. G06F 9/46

(52) U.S. Cl. 705/8

(57) ABSTRACT

A computer implemented method for improving project risk management based on (a) a quantitative analysis of risks affecting activities, i.e., the root factors leading to cost and time overruns on an activity by activity basis, and (b) an optimization of the resources allocation to each activity in the project plan, is employed to maximize the probability of completing projects on time and within-budget. The method can be employed prior to proceeding with one or more projects, but is also advantageous in that it is adaptive in the sense that more information can be learned during the course of a project about the risk factors present in the project, and this information is used to enable dynamically re-allocating resources to ensure a better outcome given an updated risk profile. Preferably, a Bayesian Belief Network (BBN) is used to capture how risk factors identified by project managers influence individual activity durations.

### BACKGROUND OF THE INVENTION

1. Field of the Invention

The present invention generally relates to risk analysis for services project management by measuring and managing duration of activities and, more particularly, to a project risk management process that performs steps which will identify the best resource scenario in order to maintain the project schedule and budget, and/or to provide corrective or remedial controls to bring a project back on schedule and budget. The project risk management process utilizes a computer resource based collaborative resource management system that assists in the identification of critical resources and allows those resources to be shared across projects to ensure timely and efficient completion of one or more projects. An important feature of the invention is that it addresses risk management for a plurality of activities across one or more concurrent services projects within an organization.

2. Background Description

Service projects consist of multiple activities that take certain amounts of time (duration) and resources to complete. Since the time it takes to complete an activity is uncertain, there is a need to understand and manage such uncertainty. During project planning and execution, program managers have been generally unsuccessful in managing the risk factors that cause such uncertainty. Known techniques and solutions for project management do not have well established and articulated ways to deal with uncertainty and risk. Known solutions typically use point estimates of activity durations and costs. They also assume a single resource scenario for an activity. Point estimates do not reflect the potential uncertainty in activity duration and cost, and therefore do not give any indication about the overall risk of a project. In addition, a single resource scenario does not leave any flexibility to activity managers and project managers to alter the project duration by changing resource allocation. As a result of the lack of such techniques, it is common for projects to go over budget and get delayed.

Multiple papers discuss risks that occur specifically in the context of outsourcing engagements. In a recent paper, H. Taylor, “Critical Risks in Outsourced IT Projects: The Intractable and the Unforeseen.” Comm. ACM 49 (11), 75 (2006), identified overoptimistic schedules and budgets as the most likely risk to occur, and probably the most difficult to mitigate. A. Cole, “Runaway Projects—Cause and Effects.” Software World (UK) 26(3), pp. 3-5 (1995) also points out that runaway IT projects, even those in services, often have significant overruns in both cost and schedule. Interviews with project executives and project managers reinforce that outsourcing transition engagements often are problematic with respect to projected schedules and resource costs.

Many other surveys attempt to catalog project-level risks—see, for example, M. Sumner, “Risk Factors in Enterprise Wide Information Management Systems Projects.” Journal of Information Technology, Volume 15, Number 4, December 2000, L. Wallace and M. Keil, “Software Project Risks and their Effect on Outcomes,” Comm. ACM, Vol. 47 (4), April 2004, and H. Taylor, “The Move to Outsourced IT Projects: Key Risks from the Provider Perspective,” Proceedings of the 2005 ACM SIGMIS CPR conference on Computer personnel research, Atlanta, Ga., Apr. 14-16, 2005. These surveys mostly apply to software development, but are relevant to services outsourcing, which often includes some level of software integration or implementation. In addition to cost and schedule, risks often mentioned include poorly documented or misunderstood contracts or requirements, inexperienced project management, frequent scope changes, and lack of a shared vision between the client and the vendor. However, there seems to be little agreement on how to take risks into account during project planning or implementation. T. Addison and S. Vallabh. “Controlling Software Project Risks—an Empirical Study of Methods used by Experienced Project Managers.” Proceedings of SAICSIT, pp 128-140, 2002, surveyed project managers and identified a set of risks and their most commonly reported mitigation strategies, but in general, little guidance on quantitative steps in risk mitigation is found.

The BBN approach to quantifying project risks is becoming increasingly popular. Chin-Feng Fan and Yuan-Chang Yu, “BBN-based Software Project Risk Management,” J. Systems and Software 73(2), pp. 193-203, 2004, designed a BBN-based procedure to support decision-making through continuous monitoring of risks during execution of a project. Their approach modeled risks based on the probability of occurrence multiplied by their potential damage cost. They considered the total cost of an activity as a combination of the increased cost due to added resources weighed against the decreased risk as the activity neared completion. This provided an optimization point for tradeoff of cost and risk. As an ongoing project was monitored, project metrics were fed into a BBN to update the risk estimates for the optimization step.

D. Nasir, B. McCabe and L. Hartono, “Evaluating Risk in Construction-Schedule Model (ERIC-S): Construction Schedule Risk Model.” J. Construction Eng. and Management, 129(5), pp. 518-527 (2003), identified risks in construction schedules and formed a BBN to capture the risk interrelationships. The conditional probability tables for the BBN were determined through interviews with experts. They then connected this risk network to a set of eight categories, or groups, of activities to estimate the effect of risk factor combinations on the durations of actual activities within each group. The disadvantage of this approach is that it does not specify the risks tied to each individual activity within a project. Further still, this does not identify specific risk factor combinations that affect the duration of each activity separately and cannot look across multiple projects being performed concurrently.

There is a need for a simplified computer implemented method for project risk management. There is a particularly acute need for a computer implemented method which assists a manager in making changes after a project has begun to get the project back on schedule and on budget. Further, within an organization that has multiple projects, there is a need for a computer implemented method for project risk management which takes into account resource sharing amongst several projects.

### SUMMARY OF THE INVENTION

It is therefore an exemplary embodiment of the present invention to provide a computer implemented project risk analysis method for at least one of one or more projects each of which can be broken down into a plurality of activities. In this exemplary embodiment, the activity durations are estimated based on resource allocations for the activity, and a plurality of risk factors for the completing the projects are mapped to one or a plurality of the activities to provide quantitative project planning information which accounts for various risk factors. Mapping of the risk factors to activities can be structured according to a Bayesian Belief Network (BBN).

Another exemplary embodiment of the present invention is to provide updating of the plurality of risk factors after a project has started and before it has been completed. This allows for calculating risk factors based on information obtained not only from historical data and/or expert opinion (as will be done to assess project management risks at the beginning of a project), but also from the preliminary and ongoing project data itself. This will allow managers to better adapt to project management risks and be aware of risk factors which are greater or lesser than originally expected from historical data and/or expert opinion (i.e., the number assigned to or calculated for any one of a plurality of risk factors may change). Furthermore, the number of risk factors can be increased or decreased

Yet another exemplary embodiment of the present invention is to provide a method for project risk analysis which identifies a set of resource types, a number of resources for each resource type, and a level of skill for reach resource type. By using a computer implemented method, a resource allocation per activity can be estimated and used in the project risk analysis

Another exemplary embodiment of the present invention is to provide a computer implemented method for optimizing project planning by performing an iterative analysis of each of the plurality of activities against each of the possible plurality of risk factors to calculate an empirical probability distribution and a resource scenario that meet or exceed one or more criteria. These criteria may include but are not limited to minimizing cost to time ratio, minimizing project costs subject to meeting target project duration, minimizing project duration subject to meeting target projected budget, minimizing project cost subject to probability of meeting target project duration, and minimizing project duration subject to probability of meeting target project budget, etc.

According to the invention, there is provided an Adaptive Project Risk Management (APRM) method that can be used to manage project risk. The method relies on statistical estimation techniques to predict project time and cost, and to drive re-planning. The estimation techniques are based on detailed project status information combined with analytical risk models. The invention addresses the risk factors in terms of their impact on relevant project activities and integrates the inherent resource flexibilities in a project that allow it to recover from unplanned delays. The analysis and optimization is performed for each of multiple activities in the one or more projects and for each of a plurality of risk factors.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of single project view of the Adaptive Project Risk Management System.

FIG. 2 is a block diagram of multiple project view of the Adaptive Project Risk Management System.

FIG. 3 is a flow diagram of the Adaptive Project Risk Management method.

FIG. 4 is a flow diagram of an optimization algorithm.

FIG. 5 illustrates a Bayesian Network representing risk factors and activity durations.

FIG. 6 is a Projection of Value Earned for an illustrative project.

FIG. 7 represents the evolution of value earned (as defined in EVM).

FIG. 8 represents the probability distribution of project completion.

### DETAILED DESCRIPTION OF THE PREFERRED EMBODIMENTS OF THE INVENTION

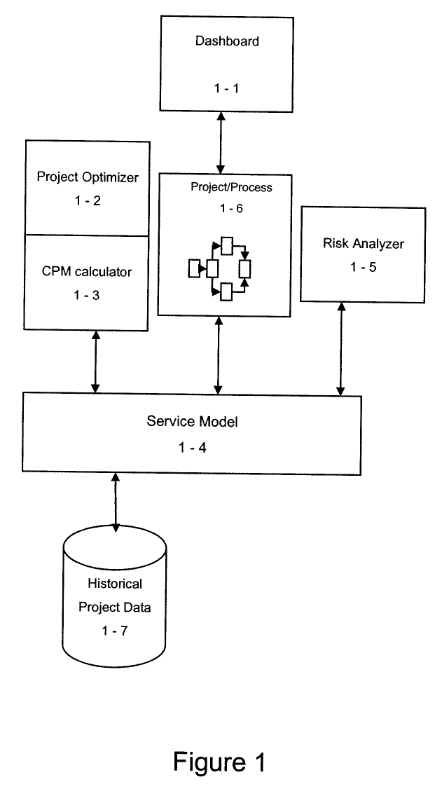

Referring now to the drawings, and more particularly to FIG. 1, there is shown a system level diagram that identifies the computer resource based elements of the adaptive project risk management system.

Its major elements include a dashboard (1-1) that allows resource sharing and allocation across multiple projects and enables monitoring and managing project/program/resource. A risk analyzer (1-5) allows planning based on historical risk impact data and/or expert opinion data. In the preferred embodiment, the risk analyzer (1-5) allows for learning from the performances of completed activities during project execution by providing a technique that associates risk factors to specific activities and estimates their impact on activity durations and costs.

The system also includes a project optimizer (1-2) and CPM calculator (1-3). The CPM calculator (1-3) performs probabilistic critical path method (CPM) calculations while the project optimizer (1-2) performs project plan optimization through resource selection and allocation. The project optimizer (1-2) calculates histograms, probabilities, confidence intervals of durations, and costs for activities and the projects. The historical project data (1-7) keeps historical data of risk factors, activity durations, and costs for a variety of projects which have been completed. The historical project data (1-7) may be consulted to determine risk factors and activities for a project that is about to be performed or to assess the relative performance of an ongoing project. Expert opinion data might be used as a substitute for or in addition to historical project data (1-7). Finally, the service model (1-4) provides alternative resource scenarios for each activity; provides resource cost data, skill data, project plan data, activity status data, activity risk; keeps output data; captures inputs and outputs of all components; and integrates the interaction between the components.

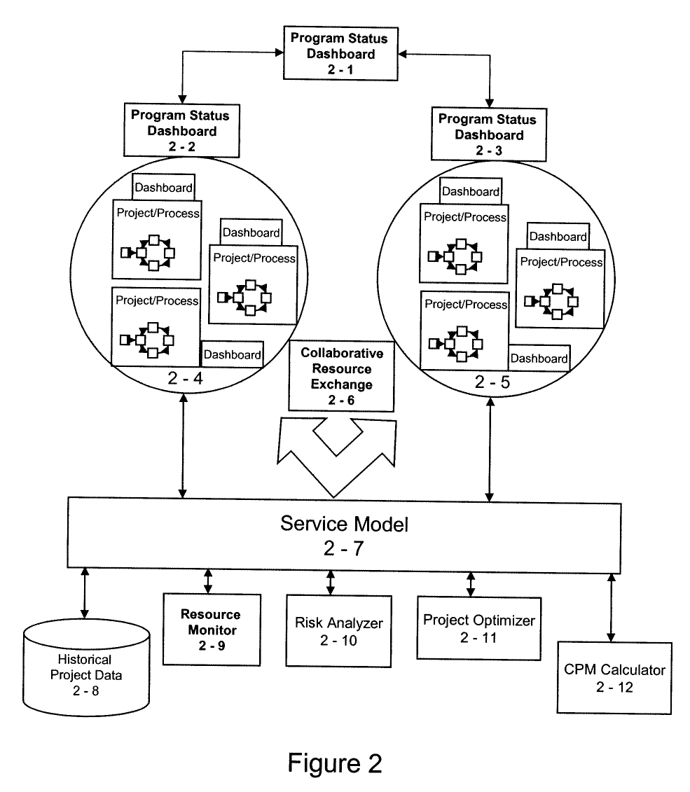

FIG. 2 is similar to FIG. 1 in that is contains all the same elements. However, FIG. 2 shows an exemplary mechanism which enables the system components to expand across multiple projects. The dashboard (2-2) and dashboard (2-3) consolidate the interfaces of each of the individual dashboards within the project/program enclave (2-4) and project/program enclave (2-5), respectively. Program status dashboard (2-1) provides the integration interface among the various enclaves. In this instance, enclaves can be thought of as different divisions within a corporate entity and the program status dashboard (2-1) would provide the integration and communication across the entire enterprise to link resources in various divisions. Those skilled in the art will understand that this is a simplification of the multiple project situation and many other configurations for accommodating relationships between concurrent projects are possible.

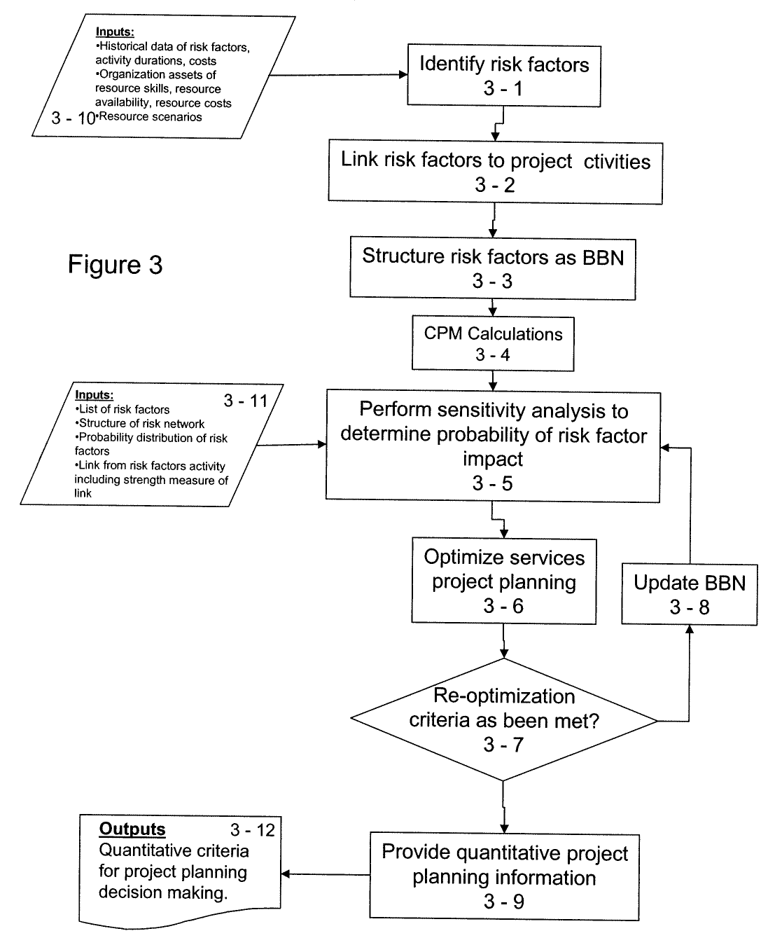

Turning now to FIG. 3, an exemplary process which is implemented by a computer for project risk management is described. Depending on the circumstances, several steps shown in FIG. 3 may or may not be performed (i.e., they are optional). Initially, the plurality of risk factors are identified (step 3-1) and are expressed in terms of their impact on the plurality of related project activities (step 3-2). The risk factors and the project activities can be derived from the input data (step 3-10) which includes but is not limited to historical data of risk factors, activity durations, costs, etc. (preferably all of which are stored on a database accessible by the processing computer) as well as expert opinion on risk factors, activity durations, costs, etc. There is also provided as input (step 3-10) the organizational information such as but not limited resource skills, resource costs, resource availability, and resource scenarios, etc.

Project risk factors are mapped to one or more of the plurality of activities which are required for any one project. Mapping can take the form of organizing the risk factors and activities into a Bayesian Belief Network (BBN) (step 3-3) which allows risks to be causally linked to each other as well as to the activities in the project. A concept behind the BBN representation is simply the given assumption that activities exposed to the same risk factors will experience correlated uncertainty levels.

Other representations which map risk factors to activities may also be used in the practice of the invention.

Another use of the BBN representation of risks is the ability to learn and update quantitative risk-activity relationships. Thus, historical data about risks encountered in past projects can be leveraged to estimate the uncertainty of the durations of similar activities performed in future projects. Beyond this inter-project learning, the structure of the risks captured by the BBN enables intra-project learning. That is, during the execution of a project, the durations of completed activities provides guidance to estimate the impact of existing risk factors on durations of future activities. Since the risk network that may be constructed is the combination of project-specific information and information gathered from past projects, this enables several types of learning and adapting to project risks in mid-stream.

For example, the BBN enables project managers to learn during the course of the project from completed activity durations. The basic idea is that if early activities suffer from delays, it is likely that one or several risk factors are present and may be present at greater levels than projected from historical data and/or expert opinion, and thus future activities will take more time than expected. While this idea is fairly intuitive, the interpolation of current delays towards future delays is less straightforward. There, the BBN structure automates the estimation, updating probabilities of risk factors present, based on observed completion times and then updating the duration of future activities impacted by these risk factors. These computations are readily carried through BBN software, for instance GeNIE developed by the Decision Systems Laboratory of the University of Pittsburgh (http://dsl.sis.pitt.edu). The input needed from project managers is now reduced to informing of activity completion times and, if relevant, of observed risk factors.

The top structure of the BBN, being common across project, can be learned from historical data, and in turn updated (step 3-8) during or after a project is completed. Several algorithms are available for this purpose; see for instance, J. Myers, K. Blackmond Laskey and T. Levitt, “Learning Bayesian Networks from Incomplete Data with Stochastic Search Algorithms,” Proceedings of the Genetic and Evolutionary Conference, Orlando, Fla., 1999. Some algorithms even accommodate missing data. Note that standardization of project activities would further enable learning the full network, including the links from risk factors to activity durations.

Based on observed or estimated uncertainty levels of activity durations, the uncertainty of the entire project duration and cost can be estimated. A critical path analysis (step 3-4) is performed to calculate the probability of any activity being on the critical path for project completion, taking into account the estimated uncertainty levels of activity durations through Monte Carlo simulation. Then, optionally, a sensitivity analysis (step 3-5) can be performed to determine the probability distribution of project duration and cost, and their confidence intervals. In particular, the sensitivity analysis (step 3-5) can estimate the effect of mitigating a risk factor (e.g., implementing incentive programs, etc.) on activity durations, and allow for re-assessing project cost and schedule. By estimating the benefits of risk mitigation actions, the computer implemented method provides project managers with quantitative information to guide their decisions.

The data used as input (3-11) to the sensitivity analysis (3-5) can be that information which has been developed in the previous steps of the method and can include but may not be limited to the list of risk factors for each of the possible projects, the structure of the risk network from step 3-3, the probability of risk factors, and the link (or mapping) of risk factors to activities.

The services project planning preferably can be optimized (3-6). This optimization takes place with or without performing sensitivity analysis (3-5). In the case of one project, the resources are allocated to improve the activity duration to fall within target levels. For the case of multiple projects, the resources are allocated across the plurality of projects and plurality of activities to come as close to target levels as possible. At this point, the project manager can decide if re-optimization criteria have been met (step 3-7).

The computer implemented provides quantitative planning information to the project managers (step 3-9). This can be provided in the form of written and printed reports, e-mailed reports or messages, audio and/or visual displayed information on a computer display or other device. The quantitative data (3-12) can include but is not limited to project specific resource days on task, cost of resource, availability of resource, etc. If the optimization criteria have not been met, the invention will update the BBN (step 3-8) as described earlier.

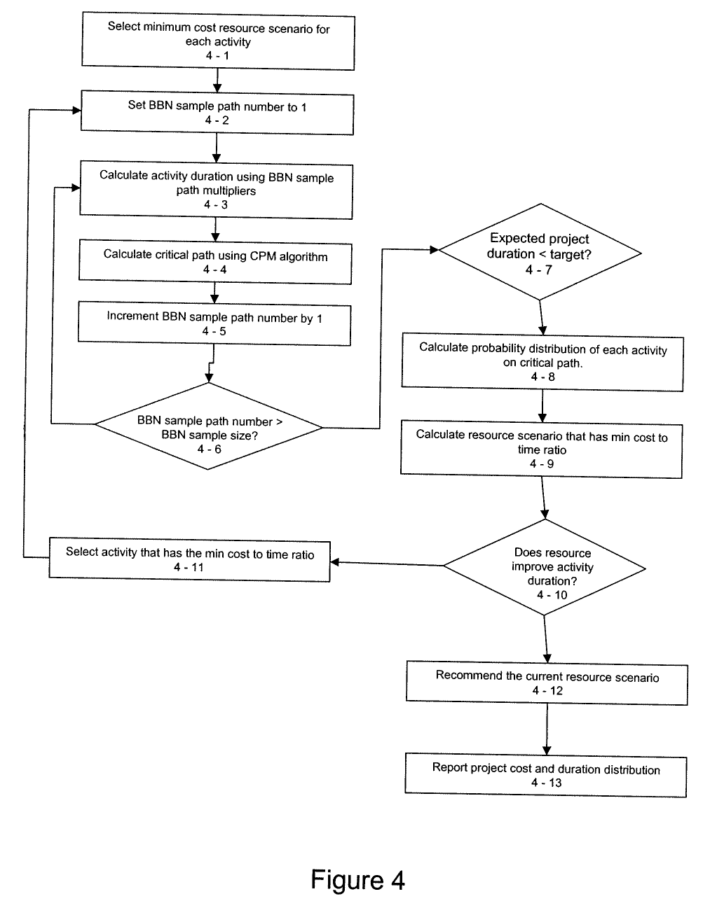

FIG. 4 describes an exemplary algorithm that performs the project plan optimization. The assumption is that a set of resource scenarios can be associated with each activity. Each resource scenario for a given activity is characterized by:
a set of resource types,
a number of resources for each type,
level of skill for each type, and
estimated activity duration (riskless) given this set of resources.
   The decision variables of the optimization problem are the resource scenario selections for all activities.

To incorporate uncertainty from risk factors into the algorithm, any currently available risk analysis simulation can be used such as but not limited to Monte Carlo simulation. Each repetition of the simulation is associated with one sample path of activity duration derived from the BBN, i.e., a set of activity duration multipliers which has been sampled from the BBN.

It is not practical in practice to evaluate all combinations of resource scenarios since there are potentially too many combinations. For instance, a project that has 100 activities, each having 5 resource scenarios will have 5¹⁰⁰ resource scenarios. Therefore, it is recommended to find a heuristic for eliminating scenarios that are not likely to be optimal. FIG. 4 provides a flow chart of the optimization steps that would be performed when the optimization criteria selected is cost to time ratio minimization. The optimization method can be performed using any one or a plurality of optimization criteria. These criteria may include but are not limited to minimizing cost to time ratio, minimizing project costs subject to meeting target project duration, minimizing project duration subject to meeting target projected budget, minimizing project cost subject to probability of meeting target project duration, and minimizing project duration subject to probability of meeting target project budget, etc. With reference to FIG. 4, the optimization method preferably uses the following steps to bring about a heuristic solution:
Step 4-1: Select the minimum cost resource scenario for each activity.
Step 4-2: Set the BBN sample path number to 1.
Step 4-3: Calculate activity durations using the multipliers in the current BBN sample path.
Step 4-4: Calculate the critical path using standard Critical Path Method (CPM) algorithm; calculate and record slack, cost and duration for each activity; calculate and record project cost and duration.
Step 4-5: Increase the BBN sample path number by 1.
Step 4-6: If the BBN sample path number is not greater than BBN sample size, go to Step 4-3. Otherwise continue.
Step 4-7: If the expected project duration is below the target, go to Step 4-11. Otherwise continue.
Step 4-8: Calculate the empirical probability distribution of each activity being on the critical path.
Step 4-9: For each activity on the critical path, calculate the resource scenario that has the minimum cost to time ratio.
Step 4-10: Select the activity that has the minimum cost to time ratio amongst all activities on the critical path and can improve the activity duration. Go to Step 4-2. If no resource can improve the activity durations, go to Step 4-11.
Step 4-11: Recommend the current resource scenario and report its project cost and duration distribution.

In Step 4-2, a BBN sample path is a vector of multipliers that measure the risks of activities. The effective duration for an activity is simply the product of its BBN multiplier by its riskless duration, which is an input to the problem. Therefore, a BBN multiplier cannot be less than 1.

In Step 4-7, if expected project duration is below the target duration, the algorithm stops and reports the current resource scenario as the recommended scenario. Since, in each iteration, the algorithm seeks to increase resource spending minimally while reducing project duration to the maximum, it essentially follows a greedy path to reach its recommendation.

In Step 4-8, empirical distributions are simply calculated based on recorded data from the output of the CPM run for each BBN sample path. BBN sample size is how many such runs are made.

In Step 4-9, each activity has a probability of being on the critical path. A threshold probability is used to decide if an activity should be regarded as critical or not. If its probability of being on the critical path is above the threshold, it is regarded critical. If the threshold probability is too high, there may not be a critical path. In this case, the threshold is reduced gradually until a critical path can be obtained. The best alternative scenario is the one that has the minimum cost to time ratio (CTR) which is calculated as follows:

CTR=(Activity cost under alternative resource scenario−Activity cost under current resource scenario)/(Activity duration under current resource scenario−Activity duration under alternative resource scenario)

In CTR comparison process, only those activities that can reduce the activity time are considered. Note that if an alternative resource scenario can perform the activity less expensively and faster, it's CTR is negative. Such alternative scenarios are immediately selected since they are absolutely superior.

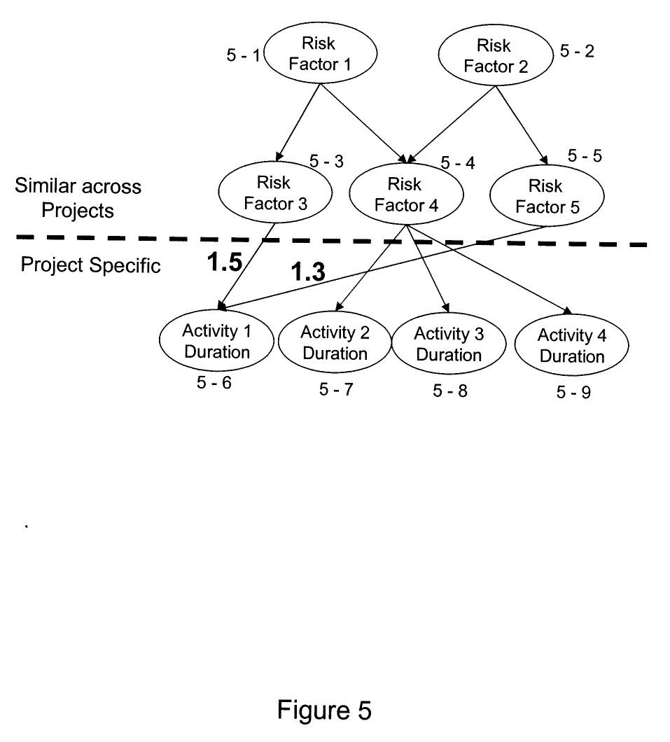

Looking now at FIG. 5, as noted above the invention preferably incorporates the notion of risk in the project plan through the addition of a Bayesian Belief Network (BBN). This network captures how risk factors identified by project managers, such as “clarity of contract terms” or “resource availability”, influence individual activity durations.

Specifically, we start from a list of risk factors (5-1, 5-2, 5-3, 5-4, 5-5) common across all outsourced services transition projects and structure them into a BBN. The conditional probability tables underlying the BBN are preferably estimated based on historical data about risk factors present in past projects. However, expert opinion may also be used to estimate risk factors. The top half of FIG. 5 reflects the risk factors that are similar across projects. The bottom half of FIG. 5, by contrast is project specific and includes activity durations (5-6, 5-7, 5-8 and 5-9). The number of activities in any one project can vary considerably. Further, the activity durations (5-6, 5-7, 5-8 and 5-9) vary depending on the resource allocation per activity. The project managers or another resource of information about the current project or projects can be used to estimate the activity durations (5-6, 5-7, 5-8 and 5-9) of a project.

The activity durations (5-6, 5-7, and 5-8) are mapped to risk factors (5-1, 5-2, 5-3, 5-4, and 5-5) that are present. As can be seen from FIG. 5, a single risk factor (5-4) can be linked or mapped to several activities (5-7, 5-8, and 5-9), and one activity (5-6) can have more than one risk factor (5-3 and 5-5). The permutations on the mapping can vary considerably depending on the project. The computer implemented method is used with projects which have more than one activity and more than one risk factor. The strength of the link between a risk factor and an activity may also be specified.

Consider activity duration 1 (5-6) in FIG. 5. If only risk factor 5-3 (5-3) is present, activity duration will most likely take 1.5 times the planned activity duration, and 1.3 if only risk factor 5 (5-5) is present. If both are present, we thus assume that the most likely increase in duration is 1.95 (1.5*1.3). The example focuses on schedule risk. The invention, however, can be extended to capture at the same time, cost risk and quality risk.

The optimization feature of the invention described in FIG. 4 can be used in a number of different ways during project implementation. Before the start of the project, it can be used to analyze the resource scenarios and find the minimum budget requirements that achieve project duration targets or can find the least possible project duration for a given budget. It can also estimate the probability of achieving duration or budget targets, etc. During project execution, after learning how the risk factors are affecting the activity durations, the computer implemented method can update the risk factors and project the remaining project cost and time to completion, assuming no changes in resources allocation (i.e., the optimization aspect of the algorithm is turned-off). Such updates can be done regularly and can be valuable in taking risk mitigation actions. Coupled with such actions, the optimization aspect of the algorithm can be invoked to re-optimize resource scenario selection in order to bring a delayed project back on schedule with minimal possible cost.

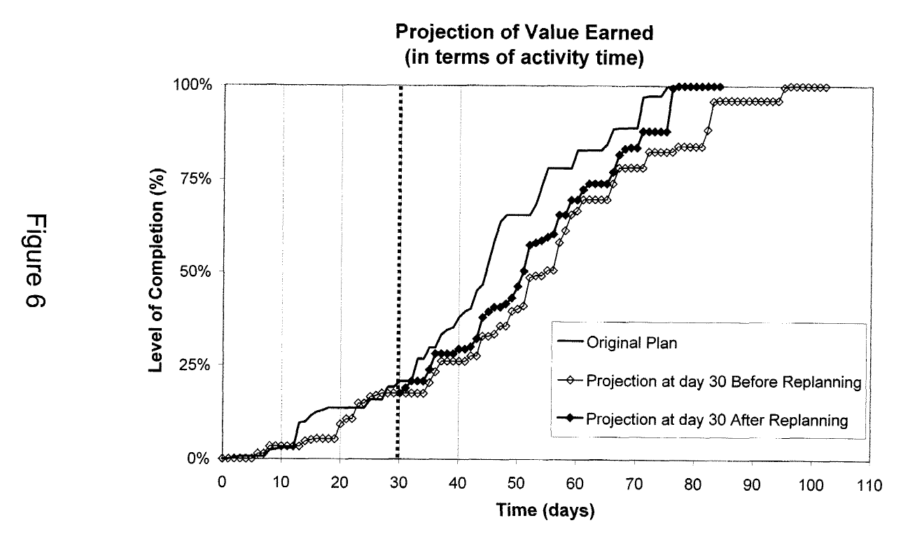

FIG. 6 illustrates the use of the optimization during an exemplary project execution. FIG. 6 represents the value earned in terms of level of completion over time for an illustrative project. 30 days after its initiation, the project is simply a few days late compared to the original plan but projections based on learning the level of risk factors indicate that at completion, it is estimated to have a delay of about 20 days compared to that original plan (completion on day 95 versus the target completion day of 75 that is originally planned). On day 30, resource scenario selection is re-optimized and the project is brought back on schedule, with completion estimated to occur on day 75 as in the original plan. This improvement in schedule may require additional costs (which may be significant). The heuristic, however, preferably seeks to provide the minimum possible cost alternative amongst all possible resource scenarios. This information will allow project managers to balance additional costs against time over runs.

As can be seen on the graph of FIG. 6, without the mitigation (re-planning) due to use of the computer implemented invention contemplated herein, the project would reach completing (100%) at day 102 while with replanning, the project was completed day 84 which is just 8 days past the original plan of 76 days rather than 26 days without the mitigation.

For exemplary purposes, the invention is described below in the context of a real customer engagement. The service being offered to the customer was based on an IT solution asset which required certain extensions and customizations to cater it towards the customer's business process. The invention was used to adaptively manage the project plans which were developed to coordinate the extensions and customizations needed to the solution asset. The project plan consisted of 62 activities completed by 15 different resource types. Some of the resource types were project manager, consultants, subject matter experts, developers, testers and network specialists. The baseline plan was developed to be completed in a certain number of days at cost of a certain dollar amount. Working closely with the project management team, two key extensions to the project plan were provided to enable adaptive project risk management.

First, the risks and the cause effect relationship between these risks were identified. Some examples of risks identified were “ill-defined requirements” and “poor communication with the customer”. A Bayesian belief network was built of these risks and mapped the leaf risk nodes to activities in the project plan. It is necessary for every activity affected by the risk to specify the most likely delay for the activity if the risk were to occur. Effective resource scenarios for most activities based on appropriately balancing the quantity, skill level and utilization of resources to the time it takes to complete the activity were defined. Some activities did not have more than the single baseline scenario, but there were numerous activities for which it made sense to factor in multiple resource scenarios allowing for flexibility in terms of cost and time.

To validate the approach, an APRM simulator was built that simulated the execution of a given project plan. The first step in the simulation was to optimize the project plan so as to minimize the project duration subject to meeting the target project budget. Based on the risks and resource flexibility extensions provided in the plan, the system projected a probability of completing the project a certain number of days earlier at a nominal cost savings. Assuming an unconstrained supply of resources, the resulting recommendations were recorded back in the project plan and effected immediately. The actual progress of the plan was simulated according to the initial recommendations of the computer implemented method described herein, allowing for random occurrence of risks affecting the activities being executed. Monthly checkpoints were introduced, simulating a project review allowing for replanning if the project was behind schedule or over budget, based on updated risk profile and available resource scenarios.

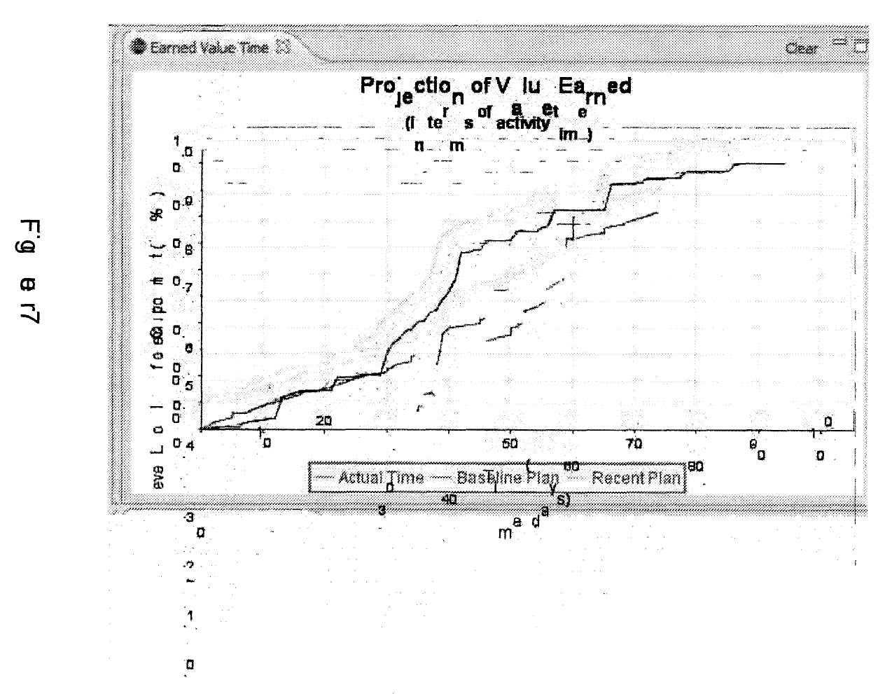

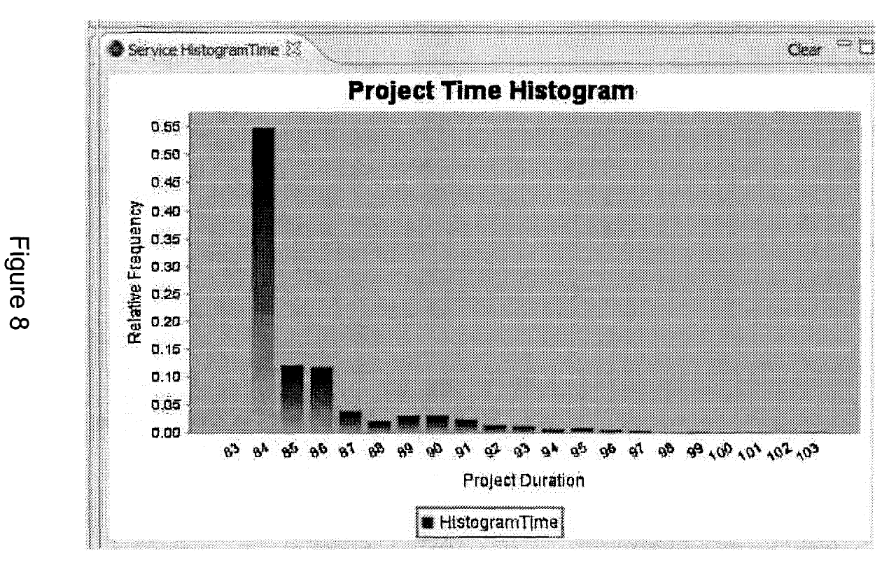

FIG. 7 and FIG. 8 present screenshots from the project progress dashboard, corresponding to day 75 in the project course. Using the actual completion time of the activities and the risk analysis method, the computer implemented method described herein enabled periodic risk mitigation by recommending appropriate resource scenarios for the remaining activities. The resulting recommendations were recorded back into the project plan which was once again fed back into the simulation. The simulation results revealed that the invention was successful in mitigating the risks by intelligently updating the resources needed to complete the activities and thereby completing the project a certain number of days before schedule within a given project budget.

While the invention has been described in terms of its preferred embodiment, those skilled in the art will recognize that the invention can be practiced with modification within the spirit and scope of the appended claims.

1. A computer implemented method for project risk management, comprising the steps of:
a) inputting into a computer or generating using said computer, for at least one project of one or more projects wherein said at least one project is comprised of a plurality of activities required to complete said project, estimated activity durations for each of said plurality of activities given a resource allocation per activity;
b) identifying a plurality of risk factors for completing said at least one project of one or more projects;
c) mapping at least some of said plurality of risk factors to one or more of said plurality of activities, wherein said mapping structures said plurality of risk factors into a Bayesian Belief Network (BBN); and
d) providing quantitative project planning information for said at least one project of said one or more projects which accounts for said at least some of said plurality of risk factors and said estimated activity durations for each of said plurality of activities.

2. The computer implemented method of claim 1 further comprising the step of updating risk factors after said project is started and before said project is completed.

3. The computer implemented method of claim 3 wherein said updating step includes calculating said risk factors based on information obtained after said project is started and before said project is completed.

4. The computer implemented method of claim 1 wherein said providing step includes the step of compounding risk factors where more than one of said plurality of risk factors applies to a single activity of said plurality of activities.

5. The computer implemented method of claim 1 wherein said step of identifying includes the steps of:
analyzing historical records of one or more prior projects; and
selecting at least one of said plurality of risk factors and said plurality of risk factors from said historical records.

6. The computer implemented method 1 further comprising the step of updating at least one of said plurality of risk factors for completing said project identified in said identifying step and said plurality of activities for completing said project input or generated in said inputting and generating step prior to completing said project of said one or more projects by determining at least one of one or more additional risk factors for said project or one or more additional activities for said project prior to completing said project, and adding said at least one or more additional risk factors to said plurality of risk factors identified in said identifying step or said at least one or more additional activities to said plurality of activities input or generated in said inputting or generating step.

7. The computer implemented method of claim 1 wherein said step of identifying includes the step of obtaining expert opinion.

8. The computer implemented method of claim 1 further comprising the steps of:
identifying a set of resource types, a number of resources for each resource type, and a level of skill for reach resource type into said computer to define a set of resources; and
determining said resource allocation per activity input into said computer or generated using said computer from said set of resources.

9. The computer implemented method of claim 1 further comprising the step of performing sensitivity analysis and assessing risk factor impact for one or more risk factors, and repeating step d).

10. The computer implemented method of claim 10 wherein said step of performing sensitivity analysis and repeating step d) are performed after said project is started and before said project is completed.

11. The computer implemented method of claim 1 further comprising the step of optimizing said resource allocation.

12. The computer implemented method of claim 12 wherein said step of optimizing is performed after said project is started and before said project is completed.

13. The computer implemented method of claim 12 wherein a plurality of projects are being performed, and said optimizing step optimizes amongst said plurality of projects
a set of resource types, a number of resources for each resource type, and a level of skill for reach resource type used for a resource allocation per activity for each of said plurality of projects.

14. The computer implemented method of claim 14 wherein said portions of said resource allocation is split among more than one project.

15. The computer implemented method of claim 1 further comprising providing at least one of a cost risk and a quality risk together with said quantitative project planning information.

16. A method for optimizing project risk management planning comprising the steps of:
a) selecting the minimum cost resource scenario for each of said one or more activities;
b) setting a BBN sample path number to 1;
c) calculating durations for each of said one or more activities using multipliers in said BBN sample path, if said BBN sample path number is not greater than BBN sample size
d) computing a critical path using standard Critical Path Method (CPM) algorithm, wherein calculating said critical path includes calculating cost and duration for each of said one or more activities;
e) increasing said BBN sample path number by 1;
f) if said BBN sample path number is greater than BBN sample size go to next step if not greater than BBN sample size go back to step c);
g) recommending a current resource scenario in terms of project cost and duration distribution if the expected project duration is below the target;
g) calculating an empirical probability distribution of each said one or more activities on said critical path;
h) for each of said one or more activities on said critical path, calculating a resource scenario that meets a selected optimization criteria wherein said optimization criteria may include but are not limited to minimizing cost to time ratio, minimizing project costs subject to meeting target project duration, minimizing project duration subject to meeting target projected budget, minimizing project cost subject to probability of meeting target project duration, and minimizing project duration subject to probability of meeting target project budget;
i) selecting an activity that meets said selected optimization criteria amongst said one or more activities on said critical path and can improve said activity relative to said selected optimization criteria and return to step b)
j) if no resource can improve the activity relative to said selected optimization criteria, recommending said current resource scenario and report its project cost and duration distribution.

17. The method for optimizing project risk management planning wherein the best alternative scenario is the one that has the minimum cost to time ratio (CTR) which is calculated as follows:
CTR=(Activity cost under alternative resource scenario−Activity cost under current resource scenario)/(Activity duration under current resource scenario−Activity duration under alternative resource scenario).

18. An adaptive project risk management system comprising:
a user interface for monitoring and managing project resources across one or more than one project;
an electronic database of historical services project data to include but not be limited to risk factors, activity durations, costs, etc.;
a system database to store adaptive project risk management data to include but not be limited to:
alternative resource scenarios for each services project one or more activities,
resource cost data, skills data, project plan data, activity status data, activity risk, and
recommendations for resource scenarios;
a computing resource for performing services project planning optimization;
a computing resource for performing risk analysis;
a computing resource for performing critical path model calculations; and
an outputting capability for providing recommended resource scenarios.

19. The adaptive project risk management system of claim 18 further comprising a program dashboard feature for integrating multiple projects and programs throughout an enterprise.

20. A machine readable medium containing instructions for performing a method for project risk management, comprising the steps of:
a) inputting into a computer or generating using said computer, for at least one project of one or more projects wherein said at least one project is comprised of a plurality of activities required to complete said project, estimated activity durations for each of said plurality of activities given a resource allocation per activity;
b) identifying a plurality of risk factors for completing said at least one project of one or more projects;
c) mapping at least some of said plurality of risk factors to one or more of said plurality of activities, wherein said mapping structures said plurality of risk factors into a Bayesian Belief Network (BBN); and
d) providing quantitative project planning information for said at least one project of said one or more projects which accounts for said at least some of said plurality of risk factors and said estimated activity durations for each of said plurality of activities.
